(19) United States
(12) Patent Application Publication
(10) Pub. No.: US 2009/0089864 A1
(43) Pub. Date: Apr. 2, 2009

(54) REMOTE MANAGEMENT OF TELECOMMUNICATIONS NETWORK ELEMENT DURING LICENSE EXPIRE AND RENEWAL PERIOD

(75) Inventors: Sebastian Tyrrell, Clonakilty (IE); Juan Solana De Quesada, Ratingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/863,907

(22) Filed: Sep. 28, 2007

(51) Int. Cl. H04L 9/32

(52) U.S. Cl. 726/6

(57) ABSTRACT

A remote management method permits the management of a license on a network element in a telecommunications network. One or more features on the network element are enabled for a predetermined time according to a license provided to the network element. Management data is sent to and received from the network element on a first management data connection. User traffic utilizing the one or more features is sent to and received from the network element on a second user data connection. The second user data connection is distinguishable from and controllable independently of the first management data connection. If the license expires, then the second user data connection is blocked, and license management data is downloaded to the network element over the first management data connection while the second user data connection is blocked. The license on the network element is renewed using the license management data downloaded over the first management data connection. After the license is renewed, the user data connection is unblocked.

### FIELD OF THE INVENTION

The present invention relates generally to the management of telecommunications networks. More particularly, the invention relates to the remote management of a network element in a telecommunications network when a license for a service or feature of the network element expires.

### BACKGROUND

There is an increasing diversity of advanced user terminals, such as mobile phones, laptop and other personal computers, and personal digital assistants (PDAs), which can communicate via various wireless and mobile networking technologies and an increasing diversity of advanced services supported by these user terminals, which administrators and operators wish to be make easily and quickly available on their telecommunications networks. The sophistication of network operators and administrators varies greatly from the administrator of a relatively small data network available simply for the convenience of the personnel of a single enterprise, to the operator of a nationwide wireless network in the business of deriving revenue from the providing both voice and data communications, as well as a variety of different related applications and services, to a large number of customers. For various reasons, some administrators or operators wish to acquire base stations and other network elements for their networks that can easily and quickly provide new communications services and features.

Such a network element typically has associated software applications and/or software packages which enable the administrator or operator acquiring the network element to control the array of services, applications and/or features available to users through that network element. A software package may facilitate various types of transmission related services, applications and/or features from a network element, such as packet-switched network (e.g., IP network) transmission services or circuit-switched network transmission services.

The software for such a network element may well have a license associated therewith. There may be license protected system features, as well as system features which are not license protected. The administrator or operator can be charged for the licensed protected features. The license protected features can be made available to users so long as the license is valid, but can be disabled if the license expires for any reason (such as failure to pay license fees).

In fields other than telecommunications, it is well known for software licenses to be purchased before or simultaneously with the purchase of the licensed software (and possibly associated hardware). It is also well known in other fields that licenses may be valid for a limited period of time or that different features of the same software package may be separately licensed. However, the management of licenses to services or features of a network element in a telecommunications network can be a logistical process of its own with unintentional adverse consequences on downstream communications, when customers wish to use certain services or features, and the administrator or operator wishes to utilize licenses in a network element to provide such services or features.

Normally, the network administrator or operator should ensure that licenses are appropriately purchased and made available to the network element in good time. However, several things can go wrong, ranging from a fault in the license to the administrator or operator simply forgetting to purchase or renew the licenses.

If a service or feature simply is made to stop working when the corresponding license expires, not only is the service or feature disabled or unavailable to users, but the management connection to the network element related is usually also lost to the extent that it cannot be remotely restored. If the management connection is lost, then remote management of the network element may not be possible and personnel will disadvantageously have to go to the physical location of the network element to restore the service or feature.

Alternatively, it may be provided that the service or feature corresponding to an unactivated or expired license is not disabled, but remains available and an alarm is simply raised to bring attention to the license expiration. The verification and enforcement can be performed later when the alarm is noticed in maintenance visits and in log files. This does not interfere with providing the licensed services or features, but has the disadvantage that the license fees must be paid retroactively after the services or features have already been used.

Oftentimes problems are encountered when attempting to renew a license. License management data has to be downloaded from a license management server to the network element. But the very service or feature for which the license must be renewed may be a prerequisite to the connection with the license management server. For example, the network element may require a certain type of transmission to the license management server (which may be disabled) so that the operator can download the needed license management data. However, since the software application corresponding to the transmission equipment of the operator may not have the transmission feature enabled, the operator may not be able to download the license management data to the network element in order to renew the license.

Conventional methods for solving the remote management lockout problem typically utilize static timeout periods. For instance, features associated with a software application and/or software package can be enabled for a certain transition period after the corresponding license expires. If the corresponding license is not installed or renewed during the transition period, the features associated with the software application are then disabled. If the feature is to be re-enabled, the corresponding license must be addressed during the transition period. After the transition period, any attempt will fail. The practical effect of such transition and timeout periods may be further dissatisfaction and frustration since, not only must the expired license be addressed, that must happen during a specific time period which is typically set far in advance and without knowledge of the circumstances at the time the license expires.

In a variation, instead of a single transition period, the service or feature could be automatically switched on and off when the license expires. The corresponding services and features could be disabled and shut off for a certain amount of time (for example, 24 hours) and then re-enabled for the following 24 hours. This may be repeated with on/off periods until the license expiration is recognized and the license is renewed during an “on” period. However, an administrator or operator may not be happy with such an approach in which the service is alternately available or unavailable, and they have to time their efforts to coincide with the proper period. They may simple decline to obtain a network element having such associated software license management.

In light of the shortcomings described above, it would be advantageous to develop a method and apparatus which addresses the problem that, when a license for a service or feature in a network element expires, the delay and expense of a person going to the location of the network element becomes necessary to renew the license. It would be preferable to have a method and apparatus that allows the administrator or operator of the network to remotely download management data to the network element after the expiration of a license, and enables the license to be renewed without the need for a person to go to the location of the network element.

### BRIEF SUMMARY

Preferred embodiments of methods and apparatuses are therefore provided which allow additional services or features of a network element to be re-enabled by downloading license management data and renewing a corresponding license despite its expiration. More particularly, the methods and apparatuses enable another network element that is remote from the network element with the expired license to download management data for a corresponding license from a database (such as a central database or a central license server) via a management data connection, even after the license expires and the user data connection is unavailable. Since the license can be renewed after expiration without a site visit, a remote management lockout situation does not occur, thereby increasing operator satisfaction and making it acceptable for the network element to be provided with certain services and features controlled by corresponding licenses.

In one exemplary embodiment, a method permits the management of a license on a network element in a telecommunications network. One or more features on the network element are enabled for a predetermined time according to a license provided to the network element. Management data is sent to and received from the network element on a first management data connection. User traffic utilizing the one or more features is sent to and received from the network element on a second user data connection. The second user data connection is distinguishable from and controllable independently of the first management data connection. If the license expires, then the second user data connection is blocked, and license management data is downloaded to the network element over the first management data connection while the second user data connection is blocked. The license on the network element is renewed using the license management data downloaded over the first management data connection. After the license is renewed, the user data connection is unblocked.

In another exemplary embodiment, a network element is provided which permits a license to be remotely managed and renewed when the license expires. The apparatus includes a processing element configured to enable one or more features on the network element for a predetermined time according to a license; send and receive management data on a first management data connection; and send and receive user traffic utilizing the one or more features to and from said network element apparatus on a second user data connection. The second user data connection is distinguishable from and controllable independently of the first management data connection. The network element also includes a management agent configured to, if the license expires, block the second user data connection and download license management data over the first management data connection while the second user data connection is blocked. The license is renewed using the license management data downloaded over the first management data connection. After the license is renewed, the user data connection is unblocked.

### BRIEF DESCRIPTION OF THE DRAWINGS

In association with the following detailed description of the preferred embodiments, reference will now be made to the accompanying drawings, where like numerals in different figures refer to the same element, and in which:

FIG. 1 is a block diagram of an exemplary telecommunications network in which the preferred embodiments of the present invention may be implemented;

FIG. 2 shows a management system for management of a network element having licensed services or features according to a preferred embodiment of the present invention;

FIG. 3 is a flowchart of a method of remote management of a telecommunications network element during license expiry and renewal according to a preferred embodiment of the present invention; and

FIG. 4 is a flow diagram of messages during license expiry and renewal according to a preferred embodiment of the present invention.

### DETAILED DESCRIPTION OF THE PREFERRED EMBODIMENTS

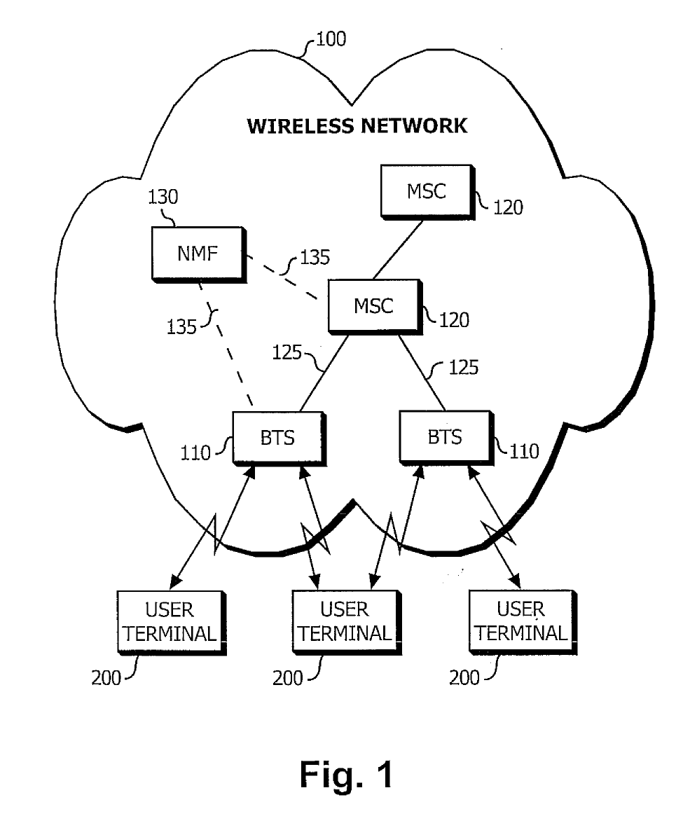

Preferred and exemplary embodiments of the present invention now will be described in detail with reference to the accompanying drawings. FIG. 1 shows an exemplary wireless telecommunications network in which the preferred embodiments related to wireless communication services and features may be implemented. It should be understood, however, that various embodiments of the present invention can be utilized in conjunction with a variety of other telecommunications network and a variety of other communication services and features.

As shown in FIG. 1, and discussed above in the background section, the wireless telecommunications network 100 includes one or more base transceiver stations (BTS) 110, each of which is capable of managing advanced communications services and features with a plurality of user terminals 200. The BTSs 110 are geographically separated from each other, as well as from a Mobile Switching Center (MSC) 120 and a Network Management Facility (NMF) 130. The MSC 120 receives and transmits data and traffic for user terminals connected to BTSs 110 over data connections 125 and routes the user data and traffic appropriately. The NMF 130 performs numerous network management functions, including remote management of BTSs 110, and MSC 120 over management connections 135.

The remote management includes remote management of licenses to BTSs 110. Although FIG. 1 shows the remote management of BTSs 110 being performed in a NMF 130 separate from MSCs 120, the NMF 130 may be co-located with a MSC 120 or the remote management of NMF 130 may be performed by an MSC 120 or by another network element so long as it is possible to distinguish user and management traffic. In particular, the user and management traffic need not be physically separate connections, and may in fact share the same physical layer of the OSI model. For example, ATM-based transport with AAL2 may be used for the user traffic and AAL5 may be used for management traffic. The wireless communications network 100 may include various gateways (not shown) to similar or dissimilar wireless networks, to a public network (such as the public switched telephone network), or to the Internet.

Each BTS 110 can transmit/receive traffic data to one or more user terminals 200. In particular, a flexible BTS can simultaneously provide a plurality of different advanced services and features to user terminals 200. These services may be those associated with third-generation (3G) cellular services in a Universal Mobile Telecommunications System (UMTS) network, and WiMax services. But of course the preferred embodiments are not limited and may be implemented in any network environment where license protected services or features are utilized in a network element. For example, in a UMTS network having a Wideband Code Division Multiple Access (WCDMA) based Radio Access Network (RAN), there may be thousands of network elements having advanced services and features which are to be independently licensed at different times depending on an operator's staggered deployment schedule for such advanced services and features after the network elements themselves are initially deployed.

Although not shown in FIG. 1, licenses can be deployed from one or more license management servers (not shown) in network 100 and delivered to BTSs 110 for deployment of the corresponding services and features. It should be understood that the licenses are preferably delivered via transmission over management data connections 135, may be deployed via any suitable process. The terms of the software license may specify that the network element is entitled to use some services or features for a limited period of time. As such, the software license management allows delivery of unique software packages with variable, customized, functionality. For example, all of the network elements may be initially deployed using communications services according to the Global System for Mobile Communications (GSM) interface while flexibly enabling future transition of selected network elements to services using a Wideband Code Division Multiple Access (CDMA) communication interface through the procurement and delivery of corresponding licenses to those network elements.

As noted above, additional features may be enabled by obtaining and deploying the corresponding licenses to the network elements. For example, the operator may receive licenses (via a download, transmission, etc.) and store them at a server which manages licenses (i.e., license management server). Subsequently, the operator may deploy the license to the selected network elements and activate the license so that the feature is enabled. The license protected service or feature can be used if a valid, unexpired, license is available and cannot be used if no such valid, unexpired, license is available.

In the preferred embodiments, user traffic and management traffic are distinguished in BTS 110 to prevent the disadvantages of the previously known methods for dealing with expiration of licenses for individual services or features. The preferred embodiments work effectively regardless of the extent to which services, features or resources of the network element are directly licensed. Generally, the licensed services or features will be those which are more advanced and/or commercially valuable. Examples of such higher level licensed features may be IMA, Asynchronous Transfer Mode (ATM) pseudowire, or ATM Adaptation Layer type 2 (AAL-2) multiplexing.

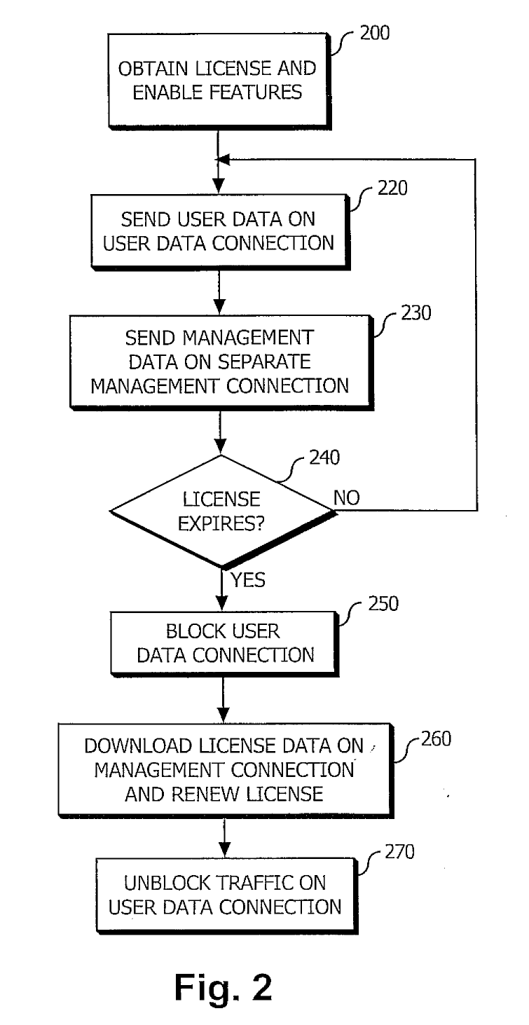

FIG. 2 succinctly illustrates a method of remotely managing BTS 110 with respect to license expiration and renewal. At step 210, the license is obtained and one or more corresponding features are enabled for a limited period of time. At step 220, user data traffic utilizing the licensed services or features is sent over a user data connection to MSC 120. At the same time, a management data connection is established for exchanging data related to managing BTS 110 (step 230).

If the license expires (step 240), then all user traffic, or at least the user data connection 125 carrying user data traffic utilizing the licensed services or features is blocked (step 250). Preferably, an alarm is raised on the affected object and its operational status is set as being operationally disabled. This status is used to trigger a block on all user traffic. The management data connection 135, however, is maintained and is not blocked. Management traffic is permitted to pass normally. Furthermore, the management data connection 135 is used to exchange license management data between BTS 110 and NMF 130 (step 260), including at least downloading data to BTS 110 authorizing the licensed services or features to be re-enabled.

The license is renewed in BTS 110 (step 270) using the license management data downloaded over the management data connection 135 while the user data connection is blocked. After the license is renewed, either all user traffic or at least the user data connection utilizing the licensed services or features is unblocked (step 280) as the case may be. If an alarm was raised on the affected object and its operational status was set as being operationally disabled, then the alarm is cleared and the operational status is set as being operationally enabled.

The preferred embodiments advantageously allow a network administrator or operator to detect and resolve a license expiration problem in a network element immediately without requiring a site visit, while still allowing the license restrictions to be enforced by the party providing the network element to the administrator or operator. This provides significant advantages, since site visits are expensive.

Even in the event where an administrator or operator, through a misconfiguration (such as downloading the wrong license file) or an oversight (such as failing to renew a license in time), loses the use of licensed services or features they can, in the preferred embodiments, restore user service quickly through remote access. If all user traffic were to be stopped, then the administrator or operator would need to physically deliver the license file to a person, who would then have to go to the location of the BTS 110, possibly leaving many hours or even days in which BTS 110 is out of service.

Since a site visit under the circumstances of license expiration is not caused by equipment failure, but instead is caused by administrative failure either on the part of the operator or the license provider, it would cause considerable operator dissatisfaction. The preferred embodiment of the invention reduces this dissatisfaction by allowing the problem to be resolved from the network management facility NMF 130.

The precise implementation of the preferred embodiments depends on the nature and the specifics of the BTS 110. For example, an ATM transport element in BTS 110 may use AAL2 connections for the user traffic and an IP/AAL5 connection for the management traffic. When the network element detects that a licensed resource has an alarm on it, the software blocks the AAL2 connections but does not block the AAL5 connection. The specific details of how the user data connection is blocked in each BTS 110 depends very much on the hardware and software architecture of the BTS 110. Of course, the preferred embodiments may be implemented in any network element so long as it is possible to distinguish and independently control the user data traffic connection and management data traffic connection within the network element.

Similarly, the specific details of how the licenses are managed and the licensed services and features are configured in each BTS 110 also depends very much on the built-in manageability features of the BTS 110. In particular, during the process in which management data is exchanged so that the license can be renewed, there may be significant differences in how the resources of BTS 110 appear available from the perspective on NMF 130. Indeed, some resources may appear as unavailable even though they still can be used for managing the element.

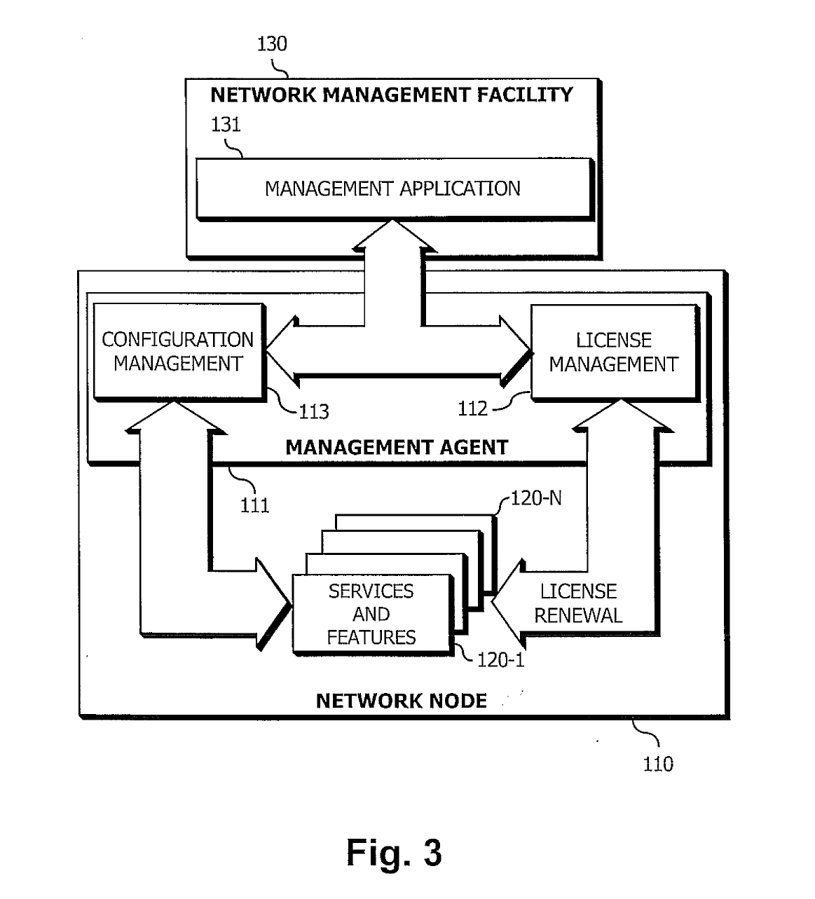

There will now be described with reference to FIG. 3, an example of a remote management system that may be advantageously used in BTS 110 and NMF 130 in conjunction with the preferred embodiments of the present invention. In this remote management system, the configuration management and the license management are totally decoupled, and thus it is possible to keep the logistical process for license renewal as a process independent of configuration. However, if required, license renewal can also be combined with any other management process. In addition, due to this flexibility, the time necessary for license renewal can be fully optimized and enables to keep the unavailability of license protected service or features due to license expiration at a minimum.

This management system includes a management application 131 in NMF 130 interoperating with a management agent 111 in the software application package of BTS 110. Management agent 111 includes license management utility software 112 to manage the distribution and validity of licenses in BTS 110, such as the downloading and deletion of licenses and the interrogation of license validity status. It also includes configuration management utility software 113 to configure the services and features 120-1 to 120-n available in BTS 110, including both those protected by the licenses managed by license management agent 112 as well as those without license protection.

The management agent 111 in BTS 110 acts as an interface to management application 131. Indeed, it may include a meta management tool that provides a unitary user interface for the combination of the license management utilities 112 and configuration management utilities 113 to personnel at NMF 130.

Configuration commands to configure a feature can be initiated by the management application 131 towards the management agent 111 which passes it on to the configuration management utilities 113. Thus, a license protected feature can be configured independently of the status of a corresponding license (and indeed before the corresponding license is deployed or renewed, which means that the license protected service or feature is configured, but not yet enabled or taken into functional use). License management related commands (such as distribute, delete, interrogate) are initiated by management application 131 towards management agent 111 which passes them on to license management utilities 112. A license is either taken into use (distributed), taken out of use (deleted), made available again for use (renewed), or the license status can be interrogated at license management utilities 112. The utilities are preferably configured to store data persistently and to check the validity of a license.

There is another operable connection between the license protected services and features 120-1 to 120-n, and the license management utilities 112. According to a preferred embodiment, this connection includes a software pattern called Observer and is configured so that during an initialization phase, a license protected system service or feature subscribes for the state and time duration of the corresponding license. In turn, the license protected service or feature gets informed/notified in case the state of the related license changes.

As described above, the deployment, deletion and renewal of a license can be executed independently of the configuration of the license protected service or feature. The license protected services or features observe during operation the status of the corresponding license by subscribing to the license management utilities 112. Dependent on the status of the related license (valid, not valid), the configured service or feature functionality is either enabled or disabled.

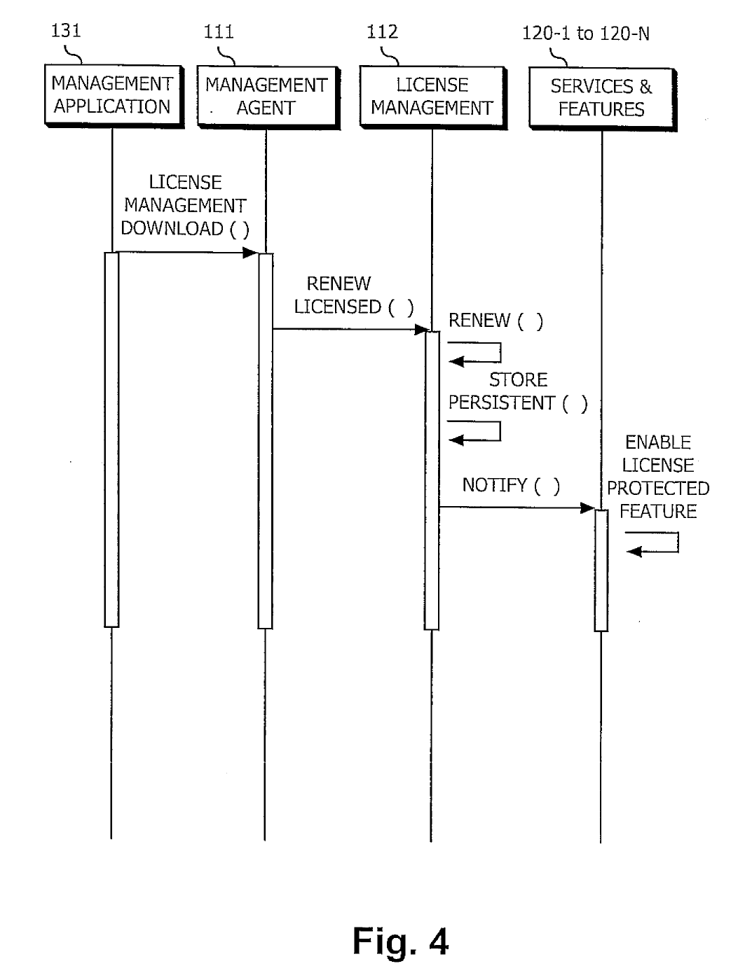

FIG. 4 shows a flow diagram illustrating a procedure to renew a license according to a preferred embodiment of the invention. The procedure begins by sending a “LicenseRenew( )” command from management application 131 to management agent 111 over management data connection 135. Then, management agent 111 sends an “validateLicense( )” command to license management utilities 112 which validate the license and store successfully validated licenses persistently by running respective “validate( )” and “store_persistently( )” routines. The presence of a valid license is notified by license management utilities 112 to the license protected service or feature 120-1.

With the configuration of the licensed service or feature 120-1 being previous independently executed and maintained despite the expiration of the license, a simple and fast routine enables the renewal of the license protected service or feature 120-1 to be quickly accomplished. The license protected service or feature 120-1 is immediately taken into use or enabled.

The preferred embodiment is not limited in its practice to a network element such as BTS 110. For example, it can also be implemented in MSC 120 or some other switching or cross-connect network element. In such a case, the switched or cross-connected user data traffic transferred between MSC 120 and BTSs 110, could be treated as user traffic to be blocked when a license expires. This would have the effect of cutting off all traffic to the downstream network elements, such as BTSs 110, but because the MSC 130 is still reachable by a management data connection from NMF 130, the license expiration problem can still be resolved without a site visit.

As mentioned previously, network 100 may include a central database or license server 131. Both the license server and the network elements may be implemented as a server computer, or the like. As such, they generally include a processing element, which can be configured in various manners; it may be comprised of a microprocessor, controller, dedicated or general purpose electronic circuitry, a suitably programmed computing device, or other means for executing software programs. The processing element may include or be connected to or otherwise be capable of accessing a memory, which can comprise volatile and/or non-volatile memory or other storage means, and typically stores content, applications, such as software applications/packages, data, or the like.

In particular, such processing element, memory, and other components of the network element are operable to execute a software program which, when executed, causes the network element to carry out the operations and functions described in this application. This software program may be provided as software program product which is installed in the network element by downloading the software program or by reading the software program from a tangible recording medium readable by the network element.

In addition to the memory, the processing element of these network elements may also be connected to at least one interface or other means for transmitting and/or receiving data or the like. In this regard, the interface(s) can include at least one communication interface or other means for transmitting and/or receiving data. The communication interface may communicate with and receive data (e.g. licenses) from external devices, using any known communication technique, whether wired or wireless, including but not limited to serial, universal serial bus (USB), Ethernet, Bluetooth, wireless Ethernet (i.e., WiFi), cellular, infrared, and general packet radio service (GPRS). Upon receipt of data such as a license, the license server may transmit the license to network elements via the communication interface. A communication interface may also enable the network elements to communicate with the license server via a network such as public network 12 (e.g., Internet) or any other suitable communication network.

The processing element may also be connected to at least one user interface that may include a display element and/or a user input element. The user input element, in turn, may comprise any of a number of devices allowing the client device to receive data and/or commands from a user, such as a keypad, a touch display, a joystick or other input device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of managing a license on a telecommunications network element, the method comprising:
enabling one or more features on said network element for a predetermined time according to a license provided to said network element;
sending and receiving management traffic to and from said network element on a first management data connection;
sending and receiving user traffic utilizing said one or more features to and from said network element on a second user data connection, said second user data connection being distinguishable from and controllable independently of said first management data connection; and
if said license expires, then
blocking said second user data connection;
downloading license management data to said network element over said first management data connection while said second user data connection is blocked;
renewing the license on said network element using the license management data downloaded over said first management data connection; and
after the license is renewed,
unblocking said user data connection.

2. The method of claim 1, wherein the status of said one or more features is set as being operationally disabled if said license expires.

3. The method of claim 2, wherein the status of said one or more features is set as being operationally enabled when said license is renewed.

4. The method of claim 1, further comprising setting an alarm if said license expires.

5. The method of claim 4, further comprising clearing the alarm when said license is renewed.

6. The method of claim 1, wherein the license management data is downloaded from a network management facility remote from the network element.

7. The method of claim 6, wherein the network management facility includes a management application which interfaces with a management agent in the network element.

8. A network element apparatus, the apparatus comprising:
a processing element configured to:
enable, on said network element apparatus, one or more features for a predetermined time according to a license provided to said network element apparatus;
send and receive management data on a first management data connection; and
send and receive user traffic utilizing said one or more features to and from said network element apparatus on a second user data connection, said second user data connection being distinguishable from and controllable independently of said first management data connection; and
a management agent configured to:
if the license expires,
block said second user data connection;
download license management data over said first management data connection while said second user data connection is blocked;
renew the license using the license management data downloaded over said first management data connection; and
after the license is renewed,
unblock said user data connection.

9. The apparatus according to claim 8, wherein the status of said one or more features is set as operationally disabled if said license expires.

10. The apparatus according to claim 9, wherein the status of said one or more features is set as being operationally enabled when said license is renewed.

11. The apparatus according to claim 8, further comprising setting an alarm if said license expires.

12. The apparatus according to claim 11, further comprising clearing the alarm when said license is renewed.

13. The apparatus according to claim 12, wherein the license management data is downloaded from a network management facility remote from the network element.

14. The apparatus according to claim 13, wherein the management agent interfaces with a management application in the network management facility.

15. The apparatus according to claim 14, wherein the management agent includes independent configuration management utilities and license management utilities.

16. The apparatus according to claim 15, wherein the license management utilities are configured to renew an expired license independent of the configuration management utilities.

17. A software program product recorded on a tangible medium, said software product, when executed by a network element, causes said network element to carry out a method of managing a license on said network element, said method comprising:
enabling one or more features on said network element for a predetermined time according to a license provided to said network element;
sending and receiving management traffic to and from said network element on a first management data connection;
sending and receiving user traffic utilizing said one or more features to and from said network element on a second user data connection, said second user data connection being distinguishable from and controllable independently of said first management data connection; and
if said license expires, then
blocking said second user data connection;
downloading license management data to said network element over said first management data connection while said second user data connection is blocked;
renewing the license on said network element using the license management data downloaded over said first management data connection; and
after the license is renewed,
unblocking said user data connection.

18. The software program product of claim 17, wherein the status of said one or more features is set as being operationally disabled if said license expires.

19. The software program product of claim 18, wherein the status of said one or more features is set as being operationally enabled when said license is renewed.

20. The software program product of claim 17, further comprising setting an alarm if said license expires.

21. The software program product of claim 20, further comprising clearing the alarm when said license is renewed.

22. The software program product of claim 17, wherein the license management data is downloaded from a network management facility remote from the network element.

23. The software program product of claim 22, wherein the network management facility includes a management application which interfaces with a management agent in the network element.
